(19) United States
(12) Patent Application Publication
(10) Pub. No.: US 2010/0180489 A1
(43) Pub. Date: Jul. 22, 2010

(54) Fish hook enclosure

(76) Inventor: Brian Benesh, Dickinson, ND (US)

Correspondence Address: CHERNOFF, VILHAUER, MCCLUNG & STENZEL, LLP, 601 SW Second Avenue, Suite 1600, PORTLAND, OR, 97204-3157, US

(21) Appl. No.: 12/070,813

(22) Filed: Feb. 20, 2008

Related U.S. Application Data
(60) Provisional application No. 60/903,126, filed on Feb. 23, 2007.

(51) Int. Cl. A01K 97/06

(52) U.S. Cl. 43/57.1

(57) ABSTRACT

An enclosure for the sharp portions of a fish hook comprises an elastic wall having a slit distortable by deformation of the wall to form an aperture through which the bite of the fish hook may pass into an interior space formed by the wall. Relaxation of external pressure on the wall permits the resilient wall to return to an undeformed condition, closing the slit and enclosing the sharp portions of the fish hook.

### CROSS-REFERENCE TO RELATED APPLICATIONS

This application claims the benefit of U.S. Provisional App. No. 60/903,126, filed Feb. 23, 2007.

### BACKGROUND OF THE INVENTION

The present invention relates to fishing equipment and, more particularly, to a protective enclosure to prevent contact with the sharpened portions of a fish hook.

Fish hooks are commonly stored in tackle boxes with lures, sinkers, leaders and other fishing equipment. Movement of the box and its contents commonly causes the hooks and other equipment to become entangled and the fisher to become frustrated. In addition, it is often inconvenient to remove a hook from the fishing line and fishing poles are commonly transported and stored with a hook attached. The possibility of snagging and tearing clothes or personal injury from inadvertent contact with the sharpened and, often, barbed portions of a fish hook are persistent threats. Treble hooks are particularly troublesome because, under most conditions, at least one of the sharpened points of the hook is exposed.

Various devices are known for shielding the sharpened portions of fishing hooks from contact with flesh, clothes and other fishing gear. For example, Lysohir et al., U.S. Pat. No. 5,123,199 discloses a protective enclosure for a fishing hook comprising a cylindrical base and a hinged, hollow hemispherical cover. The cover can be pivoted on the hinge so that the opening to the interior of the hollow hemisphere is either exposed or covered by the base. To use the protective enclosure, the fisher grasps the base with one hand and the hemispherical cover with the fingers of the other hand and pivots the cover away from the base to expose the interior of the cover. Then, continuing to hold the base with one hand, the fisher grasps the shank of the hook and with the sharpened points of hook directed at the upper surface of the base, slides the shank into a radially extending slot in the base. Once the hook is centered on the base, the user pivots the cover relative to the base so that the opening into the interior space in the cover is closed by the base. When the cover is forced against the base, mutually engaging surfaces on the cover and the base secure the cover in position, enclosing the sharp and barbed portions of the hook in the interior space defined by hollow hemispheric cover and the base.

While such an enclosure provides protection to the user and others from the sharp points of a fish hook, it can be difficult to use. If, for example, the user is ice fishing, it may be necessary for the user to remove gloves or mittens to grip and open the halves of the enclosure. Even without gloves, it may be difficult, with cold or wet fingers, to grasp the parts of the enclosure with sufficient force to unlatch and open the enclosure without a tool. In addition, the user must hold the hook by the shank with the fingers exposed to the sharp points of the hook while inserting the shank into the slot in the base. Slippage of the hook could easily result in injury. What is desired, therefore, is a fish hook enclosure to protect the fisher and others from the sharp points of a fishing hook that is easy to use even with a gloved hand.

### BRIEF DESCRIPTION OF THE DRAWINGS

FIG. 1 is a plan view of a fish hook enclosure.

FIG. 2 is a section view of the fish hook enclosure of FIG. 1 taken in the direction of line A-A.

FIG. 3 is a top view of an open fish hook enclosure.

FIG. 4 is a section view of a fish hook enclosure enclosing a treble fish hook attached to a body of a fishing lure.

FIG. 5 is a view of a plurality of enclosures for a multi-hook fishing rig including a section view of an enclosure for a single hook.

### DETAILED DESCRIPTION OF PREFERRED EMBODIMENTS

The hazards of contact with the sharp and, often, barbed portions of a fishing hook are well known. Besides painful personal injury, a fish hook may become entangled in clothes or with other gear in a tackle box. Even if the fisher does not suffer personal injury, a hook entangled in clothes or other gear can be frustrating and make fishing much less enjoyable. The present inventor concluded that a device for shielding the sharp portions of a fish hook from contact with body parts, clothes or other items of fishing equipment could enhance the fishing experience.

While a number of protective enclosures for fish hooks are known, their use often involves manipulating small pieces and extensive handling of the fish hook. This can be difficult, particularly when the user's hands are cold or wet. For example, ice fishing is a very popular and family oriented winter activity in many areas of North America, Europe and Asia. The fisher may sit on a stool in the open expanse of a frozen lake or in a cabin on the ice and fish through an opening cut in the frozen surface of the lake. Typically, ice fishers wear gloves or mittens to protect the hands from the cold. However, even when protected with gloves, the fisher's hands and fingers can get cold after prolonged exposure in freezing temperatures. If the fingers are cold, handling and manipulating small objects such as fishing hooks and the parts of a fish hook enclosure can be difficult even with the gloves removed. The inventor concluded that a fish hook enclosure operable with a gloved hand to enable a user to enclose the sharp portions of a fish hook would reduce frustration and the potential of injury while using fish hooks.

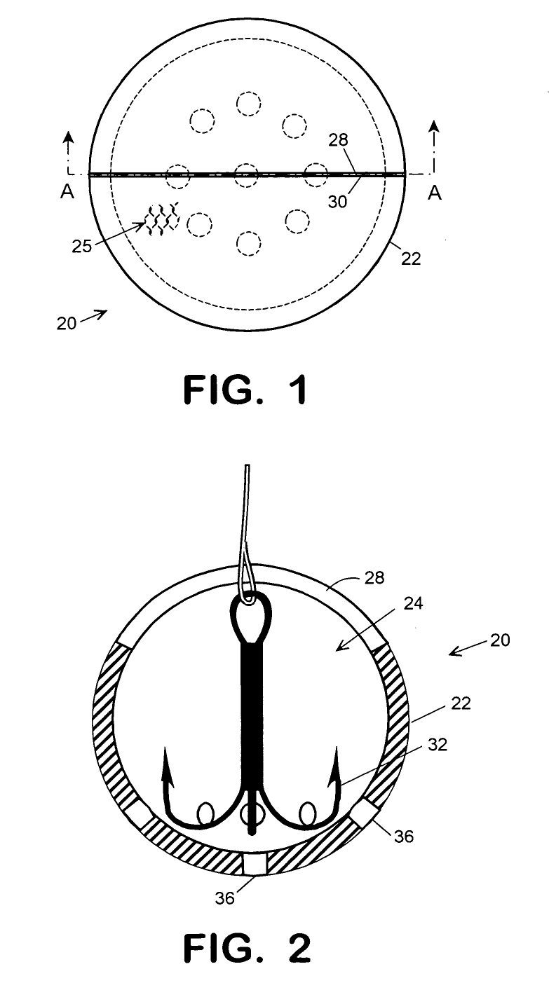

Referring in detail to the drawings where similar parts are identified by like reference numerals, and, more particularly to FIGS. 1 and 2, the single piece fish hook enclosure 20 comprises an elastic wall 22 that substantially encloses an interior space 24. The fish hook enclosure is preferably substantially spherical to simplify construction and provide an interior space that will enclose a single, double or treble hook without requiring handling of the hook to arranged the hook in a particular orientation. However, the fish hook enclosure can be any convenient shape. The wall of the fish hook enclosure comprises a resilient, elastic material, such as rubber or a plastic, such as vinyl or ethylene vinyl acetate. Preferably, the elastic material retains its flexibility and resiliency at low temperatures encountered during fishing and, more preferably, at temperatures encountered during ice fishing. In addition, it is preferable that the enclosure have positive bouncy so that it will float. The exterior surface of the enclosure can be treated, for example provided with a pebble or fabric cover 25, to increase friction between the enclosure and the user's hand and the enclosure is preferably brightly colored or fluorescent to increase visual recognition of the enclosure in dark confines of a tackle box or other low light conditions.

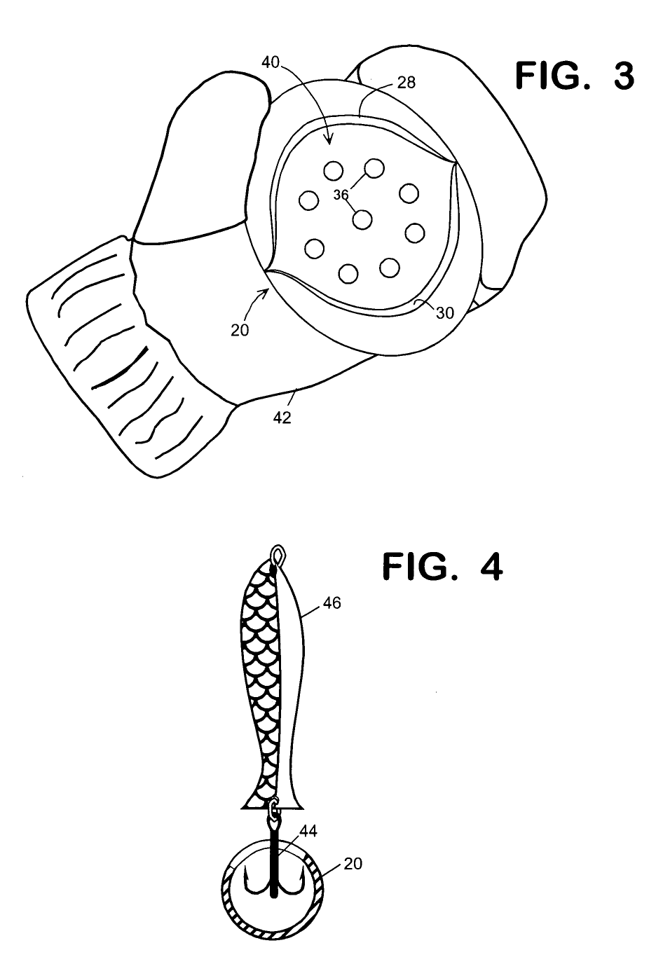

An elongate slit 26 penetrates the elastic wall of the enclosure. When the wall is in a relaxed condition, the sides 28, 30 of the slit are in contact or nearly in contact. However, referring to FIG. 3, when the elastic wall is deformed by applying external pressure proximate the ends of the slit, the opposing sides 28, 30 of the slit bend at their centers and bulge outward to form an aperture 40 through the wall to the interior space of the enclosure. The bite(s) 32, including the sharpened tips and barbs, if any, of a fish hook, for example the treble hook 34, can be passed through the aperture enabling introduction of the sharp portions of the hook to the interior space formed by the wall or removal of a hook from the space through the aperture. Since the enclosure is opened by applying pressure to the exterior of the enclosure at substantially diametrically opposing locations, the enclosure can be held in the palm of the hand 42 and squeezed between the palm or the thumb and the fingers even if the user is wearing mittens.

When the hook is in position in the interior space of the enclosure, releasing the pressure on the exterior of the enclosure's wall permits the resilient elastic wall to return to the relaxed, undeformed condition. As the wall returns to the undeformed condition, the end-to-end length of the slit increases and sides of the slit straighten and converge to close the slit. One or more apertures 36, preferably located substantially diametrically opposite of the slit, permit water to drain or evaporate from the interior space.

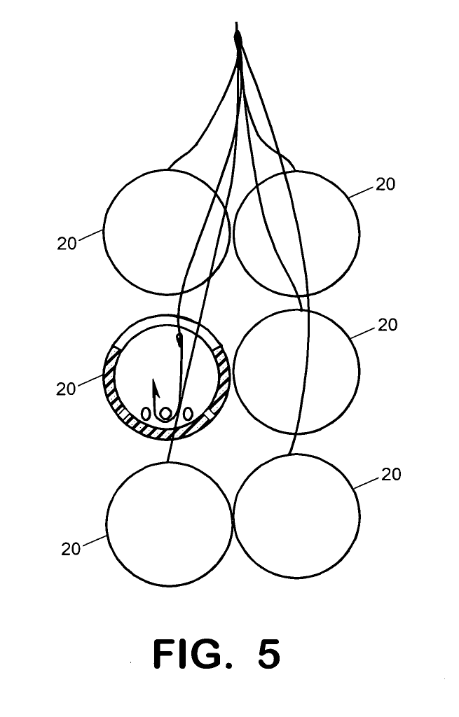

Since the wall is elastic, the sides of the slit can accommodate the interposition of a leader or line 38 attached to the hook or the shank 44 of the hook while securely shielding the sharp points and barbs on the bite 32 of the hook from contact. Referring to FIG. 4, the ability of the elastic wall to accommodate the intervention of the hook's shank between the sides of the slit permits the use of the elastic enclosure to enclose a hook that is attached to the body of a lure 46 reducing the likelihood of entanglement of the hook and other gear in a tackle box. Likewise, as illustrated in FIG. 5, a plurality of enclosures can be used with the individual hooks of multi-hook rigs. A single enclosure can be used to encase a plurality of hooks but the likelihood of entanglement of the hooks is increased.

If the hook is attached to a line or leader or the body of a lure, it is unnecessary for the user to handle the hook while inserting or removing the hook from the enclosure. While holding the enclosure in one hand with the slit uppermost, the user can open the slit by compressing the enclosure, proximate the ends of the slit, between the fingers and the palm or the thumb of the hand supporting the enclosure. With the aperture open, the user can suspend the hook over the aperture by gripping the attached line or lure body and lower the bite of the hook into enclosure. Relaxing the pressure exerted on enclosure causes the slit to close around the line or the shank of the hook. Likewise, the user can lift the hook from the enclosure by gripping an attached line or lure body. The user's fingers can remain a safe distance from the sharp points of the hook and reducing the likelihood of slipping and injury while storing a hook or removing a hook from the enclosure.

The elastic fish hook enclosure reduces the likelihood of injury through inadvertent contact with the sharpened portions of a fish hook and can be used by user wearing gloves.

The detailed description, above, sets forth numerous specific details to provide a thorough understanding of the present invention. However, those skilled in the art will appreciate that the present invention may be practiced without these specific details. In other instances, well known methods, procedures, components, and circuitry have not been described in detail to avoid obscuring the present invention.

All the references cited herein are incorporated by reference.

The terms and expressions that have been employed in the foregoing specification are used as terms of description and not of limitation, and there is no intention, in the use of such terms and expressions, of excluding equivalents of the features shown and described or portions thereof, it being recognized that the scope of the invention is defined and limited only by the claims that follow.

I (We) claim:

1. An enclosure for a bite of a fish hook comprising an elastic wall enclosing an interior space, said wall including portions defining an elongate slit, said slit distortable by deformation of said elastic wall to form an aperture through which a bite of a fish hook may be introduced to and removed from said interior space.

2. The enclosure of claim 1 further comprising a ventilation aperture in said elastic wall.

3. The enclosure of claim 1 wherein a shape of an undeformed external surface of said elastic wall is substantially spherical.

4. The enclosure of claim 1 wherein a shape of said internal space of said undeformed elastic wall is substantially spherical.

5. A method for enclosing a bite of a fish hook, said method comprising the steps of:
(a) deforming an elastic wall substantially enclosing an interior space to distort a portion of said wall comprising a slit, distortion of said slit forming an aperture in said elastic wall through which a bite of a fish hook may passed into said interior space;
(b) introducing a bite of a fish hook to said interior space through said aperture; and
(c) permitting said elastic wall to return to a substantially undeformed condition substantially enclosing said bite of said fish hook in said interior space within said elastic wall.

6. The method of claim 5 wherein the step of introducing a bite of fish hook into said interior space through said aperture comprises the steps of:
(a) positioning said elastic wall with said aperture substantially uppermost;
(b) suspending said fish hook above said aperture by a line attached to said hook; and
(c) lowering said bite of said hook into said interior space through said aperture.

7. The method of claim 5 wherein the step of introducing a bite of fish hook into said interior space through said aperture comprises the steps of:
(a) positioning said elastic wall with said aperture substantially uppermost;
(b) suspending said fish hook above said aperture by a body of a lure attached to said hook; and
(c) lowering said bite of said hook into said interior space through said aperture.
